(19) United States
(12) Patent Application Publication
(10) Pub. No.: US 2008/0099537 A1
(43) Pub. Date: May 1, 2008

(54) Method for sealing vias in a substrate

(75) Inventors: Premjeet Chahal, Plano, TX (US); Billy D. Ables, Richardson, TX (US); Sankerlingam Rajendran, Plano, TX (US); Francis J. Morris, Dallas, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 11/555,090

(22) Filed: Oct. 31, 2006

(51) Int. Cl. B23K 35/12

(52) U.S. Cl. 228/245

(57) ABSTRACT

According to one embodiment of the invention, a method for sealing one or more vias comprises providing a first substrate having vias, forming an adhesion layer on an inner surface of the vias, sandwiching a solder layer between the first substrate and a second substrate, and elevating of the first substrate, second substrate, and solder layer to a temperature above a eutectic point and below a melting point of the solder layer. The act of elevating the solder layer to a temperature above the eutectic point and below the melting point causes the solder layer to flow into the vias in a generally consistent manner.

### TECHNICAL FIELD OF THE INVENTION

This invention generally relates to substrate manufacturing processes, and more particularly, to a method for hermetically sealing one or more vias in a substrate.

### BACKGROUND OF THE INVENTION

Electronic circuitry including one or more components may be disposed on a generally flat substrate. The substrate provides a support structure for the electronic circuitry and may include one or more electrically conductive paths for the flow of electricity from one component to another. Vias having holes may also be formed in these substrates to provide an electrical connection from an upper surface to a lower surface of the substrate. The vias may also provide structural connection of the substrate to a carrier, such as a heat sink or other device having a surface for mounting the substrate.

### SUMMARY OF THE INVENTION

According to one embodiment of the invention, a method for sealing one or more vias comprises providing a first substrate having vias, forming an adhesion layer on an inner surface of the vias, sandwiching a solder layer between the first substrate and a second substrate, and elevating of the first substrate, second substrate, and solder layer to a temperature above a eutectic point and below a melting point of the solder layer. The act of elevating the solder layer to a temperature above the eutectic point and below the melting point causes the solder layer to flow into the vias in a generally consistent manner.

According to another embodiment of the present invention, a method for sealing vias comprises the acts of providing a first substrate having the vias, forming an adhesion layer on an inner surface of the vias, and sandwiching a solder layer between the first substrate and a second substrate. The first substrate, solder layer, and second substrate are then elevated to a temperature and pressure, the pressure being operable to urge the first substrate toward the second substrate such that the solder layer flows into the vias in a generally consistent manner.

Some embodiments of the present invention may provide numerous technical advantages. A technical advantage of one embodiment may include the addition of a second substrate, such as a heat sink or ground plane to the lower surface of the first substrate using a relatively inexpensive manufacturing process. Certain embodiments of the present invention may also provide a method for sealing vias that alleviates the need for relatively expensive conventional via sealing systems. One embodiment of the present invention provides a via sealing method that may use conventionally available solder materials and be processed using readily available equipment, such as an autoclave. The autoclave is a type of equipment that is adapted to provide an ambient environment having an elevated pressure and an elevated temperature. The autoclave may be utilized to provide an elevated pressure and temperature for sealing vias in a substrate in a cost effective manner.

An additional advantage is presented whereby multiple substrates may be adhered together using the method according to the present invention. In one embodiment, the method may be administered multiple times in order to adhere multiple substrates on top of one another in a stacking fashion. In another embodiment, multiple substrates may be simultaneously adhered together by stacking multiple substrates on top of one another with a solder layer sandwiched between each of the adjoining substrates.

While specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description.

### BRIEF DESCRIPTION OF THE DRAWINGS

A more complete understanding of embodiments of the invention will be apparent from the detailed description taken in conjunction with the accompanying drawings in which:

FIGS. 1a through 1d are side elevation, cross-sectional views of a semiconductor structure showing the results of a sequence of acts that may be performed to implement one embodiment according to the present invention;

FIG. 2 is a side elevational view of an alternative embodiment of the semiconductor structure of FIG. 1;

FIGS. 3a through 3c are side elevation, cross-sectional views showing various fill levels of solder within a via following an act of elevating the temperature associated with FIG. 1d;

FIG. 4 is a partial, perspective, cross-sectional view of a micro electromechanical systems (MEMS) circuit showing a via that that may be filled as described above with regard to FIGS. 1a through 1d;

FIGS. 5a and 5b are side elevation, cross-sectional views of an alternative embodiment showing the results of a sequence of acts in which a solder layer that is formed into a pattern may be used to fill vias and adhere the second substrate to the first substrate;

FIGS. 6a and 6b are side elevation, cross-sectional views of another alternative embodiment showing the results of a sequence of acts in which a solder layer that is formed into a pattern may be used to fill vias and release the second substrate from the first substrate;

FIG. 7a through 7c are side elevation, cross-sectional views of a semiconductor substrate showing the results of a sequence of acts that may be performed to create bumps on the semiconductor substrate; and

FIGS. 8a and 8b are a plan view and side elevation view respectively of an alternative embodiment of a semiconductor substrate having differing sized vias that that may be filled as described above with regard to FIGS. 1a through 1d.

### DETAILED DESCRIPTION OF EXAMPLE EMBODIMENTS OF THE INVENTION

In the following description, reference is made to the accompanying drawings that illustrate several embodiments of the present invention. It is to be understood that other embodiments may be utilized and structural and operational changes may be made without departing from the spirit and scope of the present invention.

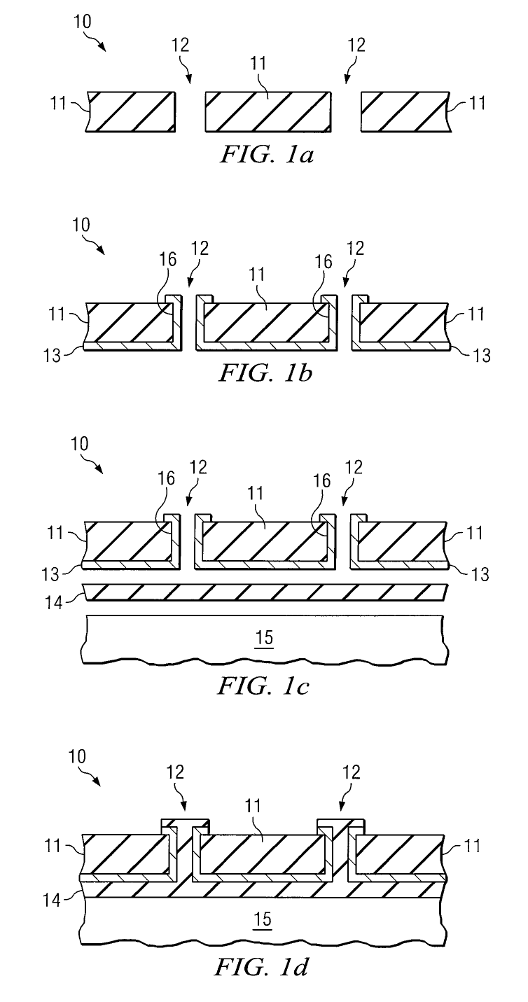

FIGS. 1a through 1d are cross-sectional drawings shown during various phases of manufacture of a semiconductor device showing one embodiment of a sequence of actions that may be performed to hermetically seal vias 12. The method for sealing vias 12 generally comprises a number of acts, the results of which are shown in FIGS. 1a through 1d. A substrate 11 having one or more vias 12 is provided as illustrated in FIG. 1a. Then, an adhesion layer 13 is formed over an inner surface 16 of each of the vias 12 as illustrated in FIG. 1b. A solder layer 14 is then sandwiched between the substrate 11 and a substrate 15 as shown in FIG. 1c. A force is applied to substrates 11 and 15 that is sufficient to exert a pressure between substrate 11 and substrate 15 while simultaneously elevating the temperature of the substrates 11 and 15 to allow the solder layer 14 to flow into the vias 12 as illustrated in FIG. 1d.

The solder layer 14 may comprise any suitable material that exhibits a phase change at a predetermined temperature and provides adequate adhesive properties to the adhesion layer 13. In one embodiment, the solder layer 14 may comprise a solder alloy comprising two or more elements with at least one of the elements being metallic. In such a case, one of the elements may have a melting point that is lower than the other element such that the solder alloy may possess a eutectic point below the melting point of the solder alloy. Therefore, the elevated temperature may be a predetermined temperature that is above the eutectic point and below the melting point of the solder alloy. The solder alloy may be considered to be partially molten when the temperature is above the eutectic point and below the melting point of the solder alloy. In this manner, the consistency of the partially molten solder alloy may be allowed to flow into the vias 12 using the force applied to the substrates 11 and 15. In one embodiment, the solder alloy may comprise a gold-tin alloy. In another embodiment, the solder alloy may comprise other solder alloys such as gold-silicon, gold-germanium, copper-tin, or palladium-silicon.

In order to urge the partially molten solder layer 14 into the vias 12, a force may be applied to substrates 11 and 15. There are several approaches for applying this force. In one embodiment, gravity is the force. In another embodiment, the force may be applied by a mechanical structure that urges substrate 11 toward substrate 15. In another embodiment, the force may be applied by elevating the pressure of the environment surrounding the substrates 11 and 15. In one embodiment, the elevated temperature and pressure may be applied simultaneously such that the elevated pressure urges the substrate 15 toward the substrate 11. In another embodiment, the elevated temperature and pressure may be supplied by an autoclave.

The substrate 15 may be coupled to the substrate 11 or be released from the substrate 11 following elevating of the temperature. In cases where the substrate 15 is formed of a material that is adapted to adhere to the solder layer following the act of elevating the temperature, the substrate 15 may be formed of a material that exhibits good surface tension or wetting properties to the molten or partially molten solder layer 14. In such a case, the substrate 15 may have a thermal expansion coefficient that is essentially similar to the thermal expansion coefficient of substrate 11. In one embodiment, the substrate 15 may be electrically conductive in order to form a ground plane for electrical circuitry on substrate 11. In addition, the substrate 15 may be thermally conductive such that heat may be conveyed away from substrate 11, thereby functioning as a heat sink. In another embodiment, substrate 15 may have one or more electrical circuits formed thereon. In such a case, the solder layer 14 may be operable to provide electrical connection of one or more electrical nodes on substrate 11 to one or more electrical nodes on substrate 15.

The substrate 15 alternatively may be formed of a material having relatively poor surface tension or wetting properties in relation to the solder layer 14. In this manner, substrate 15 may be removed from substrate 11 following elevating the temperature. In such a case, the thermal expansion coefficient of substrate 15 relative to substrate 11 is irrelevant. In one embodiment, substrate 15 may be fashioned of a relatively flexible material in order to allow bending away from substrate 11 using a peeling type action. Certain embodiments of the present invention may exhibit advantages provided by usage of a flexible substrate 15 in conjunction with the application of an elevated pressure in that the pressure may serve to evenly distribute the compression forces between substrates 11 and 15.

As described above, the adhesion layer 13 may be deposited within the vias 12 for providing adequate surface tension of the vias 12 to the solder layer 14. In this manner, the partially molten solder alloy 14 may be further urged into the vias 12 using the surface tension force of the adhesion layer 13 to the solder layer 14. If substrate 11 is conductive in nature, the vias 12 may be coated with an insulating or dielectric material using conventional thermal oxidation or chemical vapor deposition (CVD) techniques prior to application of the adhesion layer 13. However, deposition of a dielectric material may not be needed if substrate 11 is inherently insulative in nature. In one embodiment, the adhesion layer 13 may be formed of a Titanium-Tungsten alloy and the solder layer 14 may be made of a gold-tin alloy. In another embodiment, adhesion layer 13 may be formed from other metals or metallic alloys, such as Tin, Chromium, Tin-Nitrate alloy, or Tantalum-Nitrate alloy.

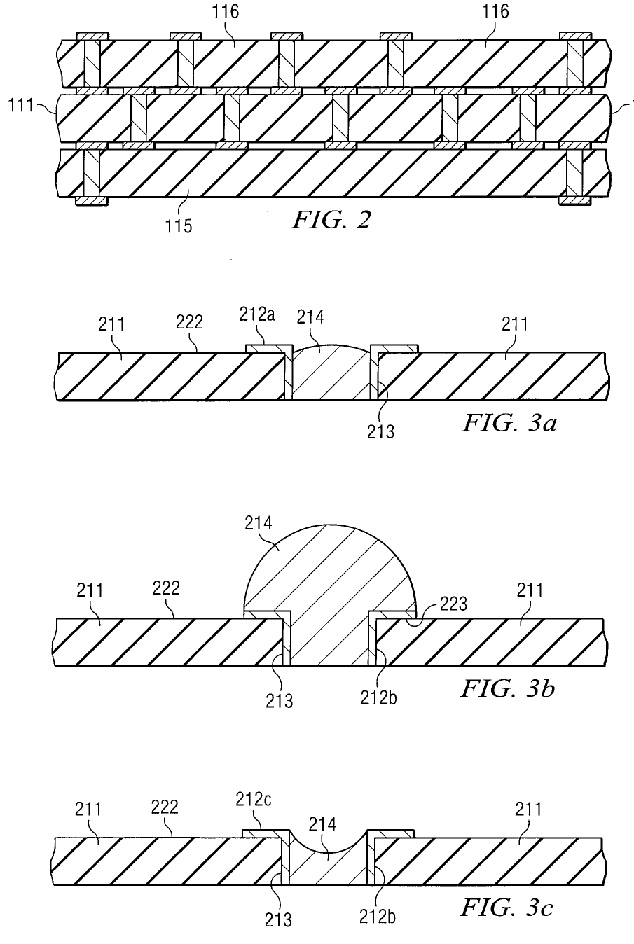

In another embodiment, the method 10 of the present invention may be performed an additional number of times as described above with regard to FIGS. 1a through 1d. In this particular embodiment, an additional substrate 116 may be adhered above the substrate 111 as shown in FIG. 2. Alternatively, the additional substrate 116 may be processed simultaneously such that the substrate 111, substrate 115, and additional substrate 116 are subjected an elevated temperature during a single sequence of actions of the previously described method 10.

FIGS. 3a through 3c shows several vias 212 having varied fill levels such as a fully filled, an overfilled, or an under filled via that may be filled as described above with regard to FIGS. 1a through 1d. The via 212a as shown in FIG. 3a has a fully filled fill level due to the solder material 214 extending generally to the upper surface 222 of the substrate 211. The via 212b as shown in FIG. 3b has an overfilled fill level due to the solder material 214 extending above the upper surface 222. The via 212c as shown in FIG. 3c has an under filled fill level due to the solder material extending to a level below the upper surface 222.

In some instances, it may be desirable to create a hermetically sealed via 212 having a particular fill level. The teachings of the present invention provide several methods of modifying the effective fill level of the vias 212. In one embodiment, the fill level of the via 212 may be modified by various physical abrasion techniques, such as lapping, polishing, wet etching, dry etching, or sanding. For example, a via 212 that is overfilled may have the overfilled portion of the solder material removed by conventional polishing, wet etching, or dry etching of the protruding solder portion. In another example, if the solder material is relatively difficult to remove, the method for sealing vias 10 may be administered on a relatively thick substrate 211. Then following completion of elevating the temperature, the upper surface 222 may be lapped down until the via 212 has a fully filled fill level. In another embodiment, the fill level of the via 212 may be further manipulated by application of a surface tension modifying agent to the adhesion layer 213. The surface tension modifying agent may comprise a relatively thin dielectric coating that serves to retard or enhance the surface tension of the solder layer 214 to the adhesion layer 213. The dielectric coating may be evenly applied over the substrate 211 or may be applied to selective regions of the substrate 211. The dielectric coating may be deposited using conventional approaches, such as, for example chemical vapor deposition (CVD) or atomic layer deposition (ALD). In another embodiment, the via 212 may have a pad 223 (FIG. 3b) that may be utilized to further control the fill level of its associated via 212. The pad 223 serves the purpose of limiting migration of the solder material 214 past the radial extent of the pad 223. The pad 223 may be integrally formed with the adhesion layer 213 and extends outwardly over the upper surface 222 to a specified diameter. Because the relatively low surface tension of the substrate 211 does not allow migration of the solder material 214 beyond the pad 223, modification of the diameter of the pad 223 may serve to further manipulate the fill level of the via 212.

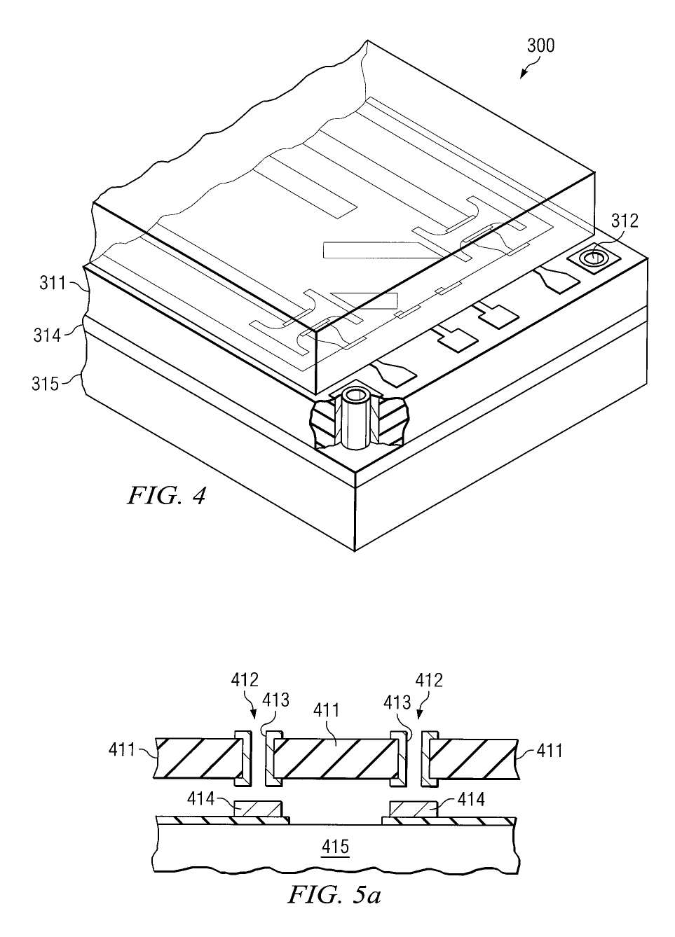

The previously described method 10 for hermetically sealing vias in a substrate may have numerous useful applications. For example, vias formed in a micro electro-mechanical system (MEMS) 300 circuit may be hermetically sealed using the above described method 10. FIG. 4 shows a perspective cut-away view of a via 312 that has been filled using the method 10 of the present invention. The substrates 311 and 315 are formed of alumina and a copper-Molybdenum alloy respectively. The alumina 311 and copper-molybdenum 315 substrates may have a solder layer 314 in between. To improve surface tension, an adhesion layer of titanium or other similar material may be deposited on either substrate 311 or 315 prior to attachment using solder layer 314. In another embodiment, solder alloys including nickel may be used to provide a necessary level of adhesion between substrates 311 and 315. In this example, substrate 315 is adhered to the solder layer 314 and operates to provide an electrical ground plane as well as structural rigidity for the micro electromechanical system circuit 300.

Certain embodiments of the present invention may provide the ability to selectively modify the thickness of substrate 311 using known thinning processes, such as lapping or polishing. That is, the method of hermetically sealing vias 10 may provide sufficient structural integrity in order to provide for lapping or polishing of substrate 311 to a relatively thin layer. In one embodiment, substrate 311 may be thinned to any desired thickness. In another embodiment, substrate 311 may be thinned to an overall thickness of approximately 50 microns.

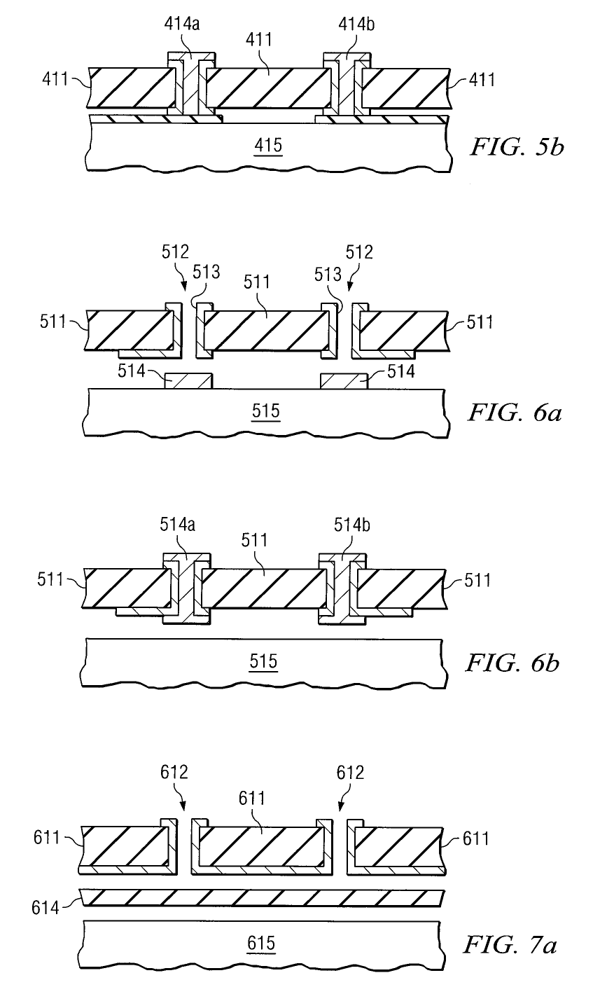

Other useful embodiments may employ the method for hermetically sealing vias 10 of the present invention. FIGS. 5a and 6a shows how the solder layer may include only selected portions or regions 414 and 514 of the substrate 415 and 515. The regions 414 and 514 when disposed upon the second substrate 415 and 515 may each be referred to as a pattern. FIG. 5b shows the results of elevating the temperature of the substrates 411 and 415 of FIG. 5a. In this particular example, substrate 415 is coupled to substrate 411. FIG. 6b shows the results of elevating the temperature of the substrates 511 and 515 of FIG. 6a. In this particular example, substrate 515 has been removed from substrate 511. As shown in FIG. 5a, vias 412 are disposed above regions 414. In FIG. 5b, the vias 412 that have been disposed above regions 414 are now hermetically sealed. In addition to hermetically sealing the vias 412, the substrate 415 is coupled to the substrate 411 via the reflowed regions 414. As shown in FIGS. 6a and 6b, regions 514 may be disposed upon the substrate 515 in a manner similar to that described above. In FIG. 6b, the substrate 515 has poor surface tension in relation to the regions 514 such that the substrate 515 may be removed from the substrate 511 following elevating the temperature.

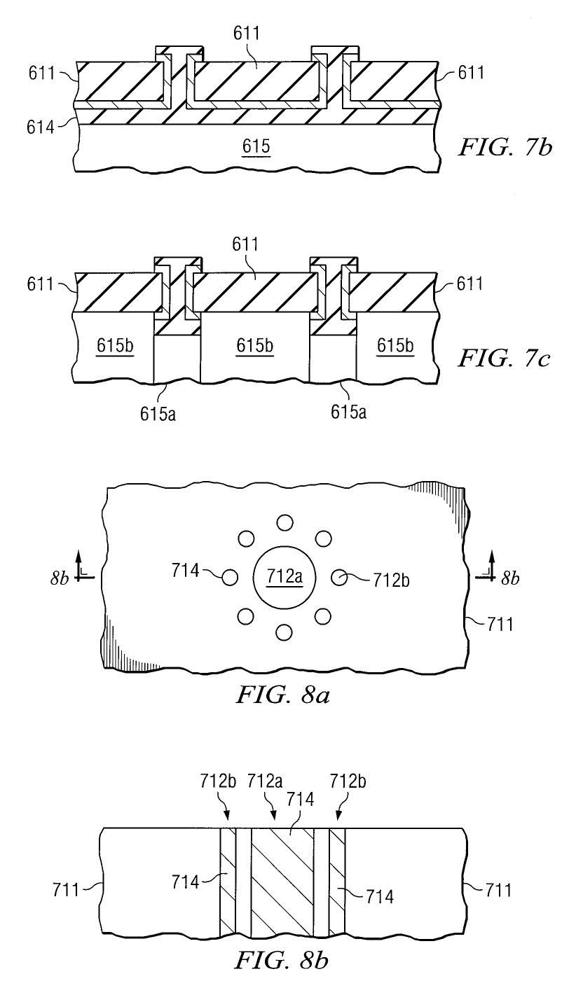

In another embodiment, the method for hermetically sealing vias 10 in a substrate may be used to facilitate the forming of projections or bumps on the substrate. FIGS. 7a through 7c are cross-sectional diagrams shown during various phases of manufacture illustrating the results of various acts associated with such a process. In one embodiment, bumps 615a may be used as spacers for placement of the substrate 611 at a predetermined distance from another object such as, for example, an inner surface of a packaging cavity. In FIG. 7a, a solder layer 614 is shown sandwiched between the substrate 611 and the substrate 615. Next in FIG. 7b, the substrate 611, substrate 615, and solder layer 614 are elevated to a predetermined temperature sufficient to allow the solder layer 614 to flow into the vias 612 in a manner similar to that described above in FIG. 1. The formation of bumps 615a are provided by cutting away undesired portions of the substrate 615b, as shown in FIG. 7c. Thus, the portion that has not been cut away forms the bumps 615a. The regions 615b show portions of the substrate 615 that have been cut away in order to create the bumps 615a.

FIGS. 8a and 8b show how the teachings of the present invention may be used to fill vias 712 of differing size. The substrate 711 as shown has several vias 712a and 712b that are disposed in spaced relation to one another. Vias 712a and 712b are structured in such a manner to form what is commonly known as a “faraday cage”. It should be understood however, that any suitable combination of vias 712 having differing sizes may be hermetically sealed using the teachings of the present invention.

As shown in this particular example, via 712a has a size that is larger than the size of the other vias 712b. Via 712a has been sealed in a manner similar to that described above in conjunction with FIGS. 1a through 1d. Thus, the combination of elevated temperature and physical force serves to allow the flow of solder 714 into vias 712 of differing size to a relatively constant fill level.

While specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description.

What is claimed is:

1. A method for sealing a plurality of vias comprising:
providing a first substrate having the plurality of vias;
forming an adhesion layer on an inner surface of the plurality of vias;
sandwiching a solder layer between the first substrate and a second substrate, the solder layer having a eutectic point that is less than a melting point of the solder layer; and
elevating the first substrate, second substrate, and solder layer to an elevated temperature and elevated pressure, the elevated temperature being between the eutectic point and the melting point, the elevated pressure being operable to urge the first substrate toward the second substrate such that the solder layer flows into the plurality of vias.

2. The method of claim 1, wherein the solder layer comprises two elements that are selected from the group consisting of gold-tin, gold-silicon, gold-germanium, copper-tin, and palladium-silicon.

3. The method of claim 1, wherein elevating the temperature and pressure comprises elevating the ambient

4. A method for sealing at least one via comprising:
providing a first substrate having the at least one via;
forming an adhesion layer on an inner surface of the at least one via;
sandwiching a solder layer between the first substrate and a second substrate, the solder layer having a eutectic point that is less than a melting point of the solder layer; and
elevating the first substrate, second substrate, and solder layer to a temperature that is between the eutectic point and the melting point such that the solder layer flows into the at least one via.

5. The method of claim 4, further comprises applying a force on the first and second substrate sufficient to urge the first substrate toward the second substrate while elevating the temperature.

6. The method of claim 5, wherein applying a force comprises elevating, by an autoclave and ambient pressure of the environment in which the first substrate, second substrate, and solder layer are disposed.

7. The method of claim 4, wherein sandwiching a solder layer further comprises sandwiching the solder layer in between a portion of the first substrate and

8. The method of claim 4, wherein the at least one via comprises a plurality of vias.

9. The method of claim 8, wherein at least one of the plurality of vias has a size that is different from the size of another one of the plurality of vias.

10. The method of claim 4, wherein the first substrate is adapted to include electronic circuitry.

11. The method of claim 4, further comprises providing a third substrate having a second via, and repeating the acts of forming an adhesion layer, sandwiching a solder layer, and elevating the temperature such that the solder layer flows into the second via.

12. The method of claim 4, wherein elevating the temperature does not cause the solder layer to adhere to the second substrate.

13. The method of claim 12, further comprises removing the second substrate from the first substrate after elevating the temperature.

14. The method of claim 4, wherein elevating the temperature causes the second substrate to adhere to the

15. The method of claim 14, wherein the first and second substrates each have thermal expansion coefficients essentially similar to one another.

16. The method of claim 14, further comprises removing selected portions of the second substrate such that at least one bump is formed on a lower surface of

17. A method for sealing at least one via comprising:
providing a first substrate having the at least one via;
forming an adhesion layer on an inner surface of the at least one via;
sandwiching a solder layer between the first substrate and a second substrate; and
elevating the first substrate, second substrate, and solder layer to a temperature and pressure, the pressure being operable to urge the first substrate toward the second substrate such that the solder layer flows into the at least one via.

18. The method of claim 17, wherein elevating the temperature comprises elevating the first substrate, second substrate, and solder layer to a temperature that is between a eutectic point and a melting point of the solder layer.

19. The method of claim 17, wherein elevating the temperature and pressure comprises elevating the temperature and pressure using an autoclave.

20. The method of claim 17, further comprises modifying the fill level of the at least one via.
